(19) United States
(12) Patent Application Publication
(10) Pub. No.: US 2026/0185322 A1
(43) Pub. Date: Jul. 2, 2026

(54) VIBRATORY DROP PLOW SYSTEM FOR AN EXCAVATOR

(71) Applicants: Derek William KENT, Becker, MN (US); David Thomas PHANEUF, Saint Cloud, MN (US)

(72) Inventors: Derek William KENT, Becker, MN (US); David Thomas PHANEUF, Saint Cloud, MN (US)

(21) Appl. No.: 19/434,856

(22) Filed: Dec. 29, 2025

Related U.S. Application Data
(60) Provisional application No. 63/739,195, filed on Dec. 27, 2024.

(51) Int. Cl. E02F 5/02; B06B 1/16; E02F 3/96; E02F 5/14

(52) U.S. Cl. CPC E02F 5/027; B06B 1/16; E02F 3/963; E02F 5/14

(57) ABSTRACT

An excavator drop plow system includes a chassis assembly connecting a vibratory drop plow to an excavator. The vibratory drop plow includes a blade connected to a shaker weight assembly for forming a trench. The chassis assembly has a rotatable connection disposed between the boom arm and shaker assembly, permitting formation of curved trenches to avoid obstacles.

### CROSS-REFERENCE TO RELATED APPLICATIONS

This application claims priority in U.S. patent application Ser. No. 63/739,195, filed Dec. 27, 2024, the contents of which are hereby incorporated by reference.

### BACKGROUND

### 1. Field of the Disclosed Subject Matter

The disclosed subject matter relates generally to soil-shifting machines, and more particularly to a reciprocating digging element and its attachment to the soil-shifting machine.

### 2. Background

Self-propelled machines, such as a backhoe or excavator with a boom arm are used to work soil. Tools are attached to the boom arm, and an operator manipulates the tool by moving the boom arm and actuating an actuator, such as a hydraulic or electro-mechanical components to position and manipulate the tool. Tools, such as plows, aid an operator in working the soil.

A plow may be pulled through the soil to bury material in the soil. A plow in the form of an elongated blade may be attached to the boom arm, and the blade plunged into the ground to form a narrow trench in the ground. A rapid, oscillatory motion may be transmitted to the blade, such as by a vibrating motor, to aid in pulling the plow blade through the soil. A cable, conduit, pipe, or other hardware can be attached by a lug or other connector to the plow blade to install such material underground at a desired depth and along a desired path, without the time, expense, and disruption of digging a traditional wide trench.

Until now there has not been available a plow system for use with an excavator with the advantages and features of the disclosed subject matter.

### SUMMARY

A chassis assembly provides a rotatable connection between a vehicle, such as an excavator with a boom arm, and a vibratory drop plow system for forming trenches in the soil.

In an embodiment, the chassis assembly includes a mounting assembly for connecting the chassis assembly to a vehicle. The chassis assembly includes a platform with a support connected thereto forming pivoting connections for connecting a plow blade to the support, where the platform is rotatably connected to the mounting assembly for rotating the blade when forming a trench in the soil.

In an embodiment, the mounting assembly includes a mounting plate with first and second ears extending therefrom for connecting the mounting assembly to the boom arm. The chassis has a stage rotatably connected to the support, and an actuator operably connected to the stage and the support for rotating the stage about the support.

In an implementation, the support is formed by a first side plate connected to the stage, forming upper and lower apertures, and a second side plate connected to the stage, forming upper and lower apertures, with the upper apertures forming the first pivot connection, and the lower apertures forming the second pivot connection. ...

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

The present disclosed subject matter is described herein with reference to the following drawing figures by way of example and are not limited by the accompanying figures for which like references indicate like elements, and with greater emphasis being placed on clarity rather than scale:

FIG. 1 is an isometric view of a plow system attached to an excavator embodying principles of the disclosed subject matter.

FIG. 2 is an isometric view from the rear and above of the plow system.

FIG. 3 is an isometric view from the rear and below of the plow system.

FIG. 4 is an isometric view from the front and above of the plow system.

FIG. 5 is a plan view of the plow system.

FIG. 6 is a side elevation view of the plow system.

FIG. 7 is a bottom view of the plow system.

FIG. 8 is an exploded view of the plow system.

FIG. 9 is a front elevation view of the shaker assembly with the front cover removed.

FIG. 10 is a cross-sectional view of the shaker assembly taken along the line 10-10 in FIG. 9.

FIG. 11 is a cross-sectional view of the shaker assembly taken along the line 11-11 in FIG. 10.

FIG. 12 is an elevation view of an aspect of the plow system embodying principles of the disclosed subject matter.

FIG. 13 is a schematic diagram of the hydraulic system.

### DETAILED DESCRIPTION

Certain terminology will be used in the following description for convenience in reference only and will not be limiting. For example, up, down, top, bottom, front, back, rear, right, left, forward, rearward, upward, and downward refer to the disclosed subject matter as orientated in the view being referred to, or in reference to such terminology designating the characteristics of an assembly as described in this description. Such terminology will include the words specifically mentioned, derivatives thereof, and words of similar meaning.

Referring to the drawings, a tool such as an excavator drop plow system 100 embodying principles of the disclosed subject matter includes a chassis assembly 150 disposed between a motorized vehicle 102, such as a backhoe or excavator, and a shaker assembly 310 used to vibrate a drop plow blade 328 as it is drawn through the ground to form a trench below the surface for the burying of material, such as cabling or conduit.

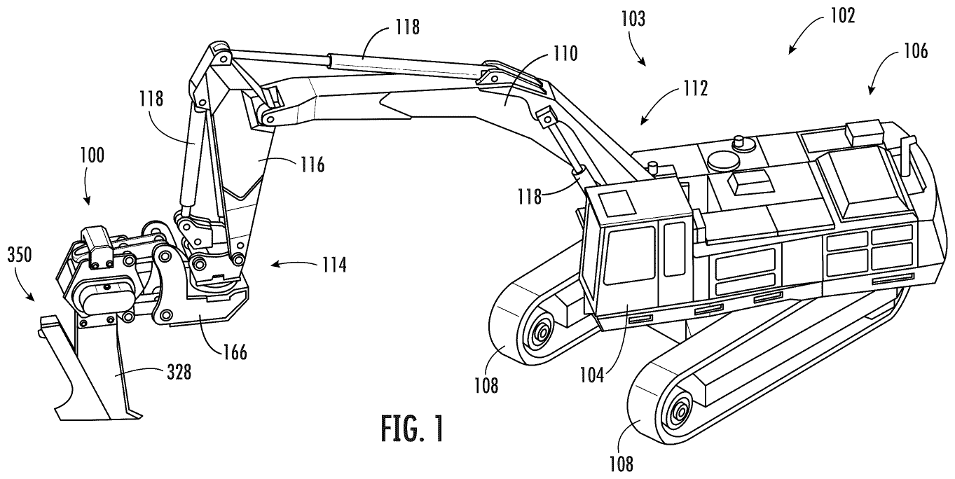

Referring to FIG. 1, the vehicle 102 may be many possible types of motorized vehicles with a boom arm, such as a backhoe or excavator 103 having a body that includes an operator cab 104 and an engine area 106. The body is mounted to and rotatable about tracks 108 for movement across the ground. A boom arm 110 is pivotally mounted at a first end 112 to the body and at a second end 114 to the chassis assembly 150 by a stick 116. The chassis assembly 150 may be formed by metal and forms a pivoting connection between the boom arm 110 and shaker assembly 310, and first and second connection points 160, 162 providing pivoting attachment points for the shaker assembly 310. The vehicle 102 further includes a means for powering the boom arm 110 for movement up and down, and rotation of the body from side to side, and means for delivering power to components of the drop plow system 100.

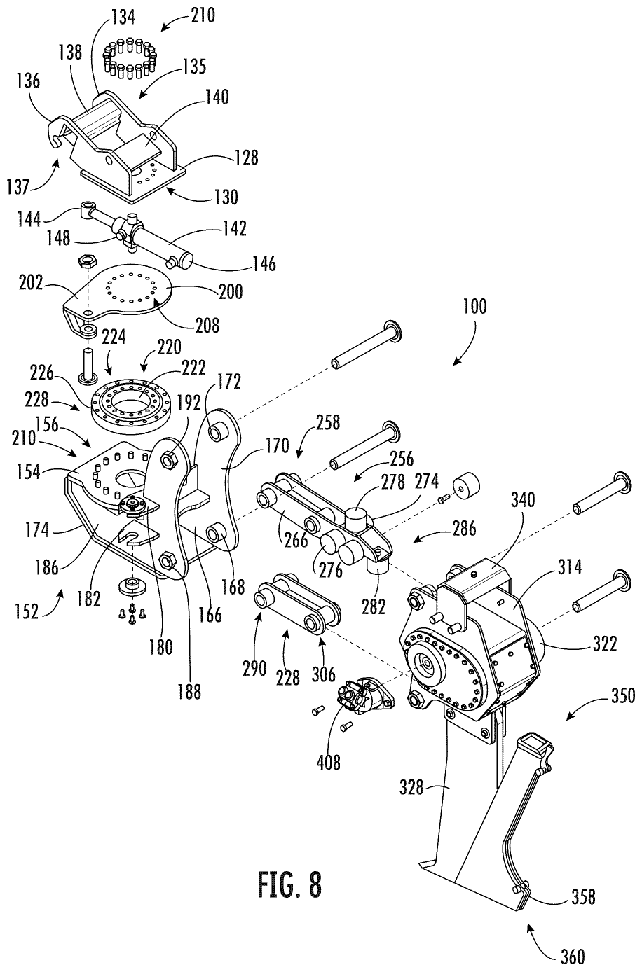

In an implementation, the chassis assembly 150 generally includes a chassis 152 rotatably connected to a mounting assembly 126 for connecting the chassis 152 to the motorized vehicle 102. The mounting assembly 126 can take several forms, and is selected based on the attachment mechanism present at the end of the boom arm 110. In an implementation, the mounting assembly 126 (as shown in FIG. 8) is manufactured from metal and includes ears 132 connected to a mounting plate 128, such as by welding, for connecting the chassis 152 to the boom arm 110 second end 114. In an implementation, the ears 132 are formed by parallel adjacent first and second side plates 134, 136 and form downwardly facing recesses 135, 137 at their rear ends. A cross tube 138 extends between the upper portions of the ears 132 and may be welded thereto, and a spacer 140 provides structural rigidity to the assembly. A fixture at the second end 114 of the boom arm 110 is adapted to engage the recesses 135, 137 and the fixture is then further secured to the mounting assembly allowing the excavator 103 to move the drop plow system 100.

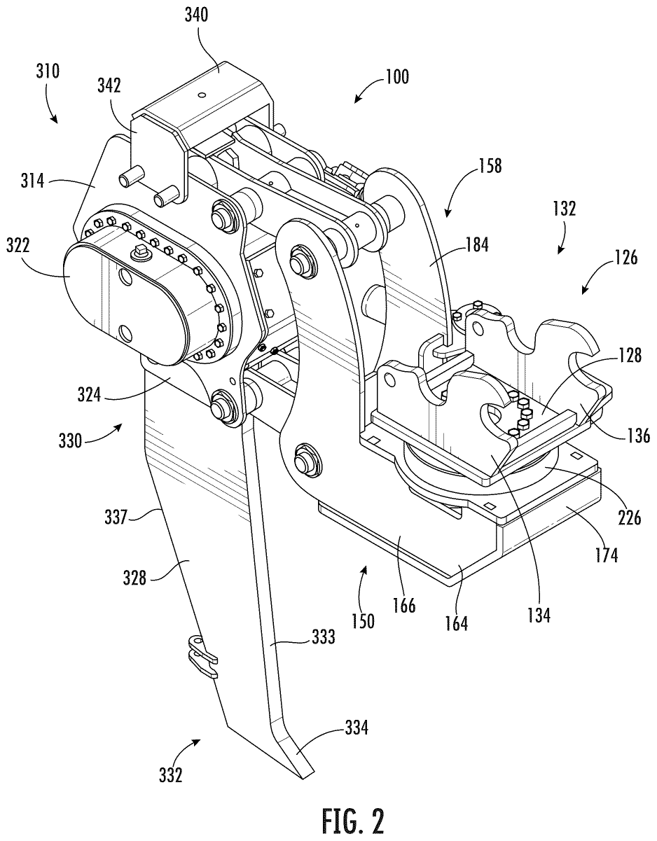

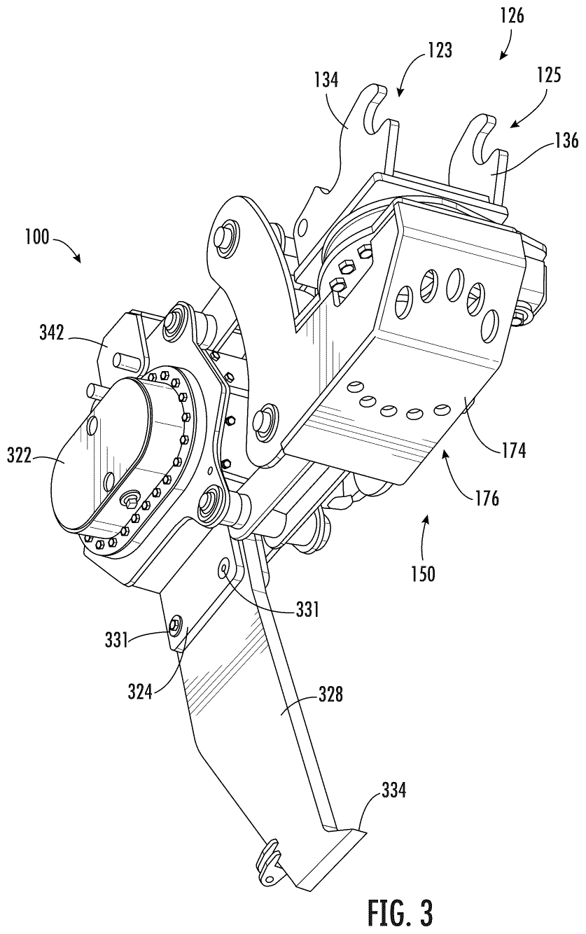

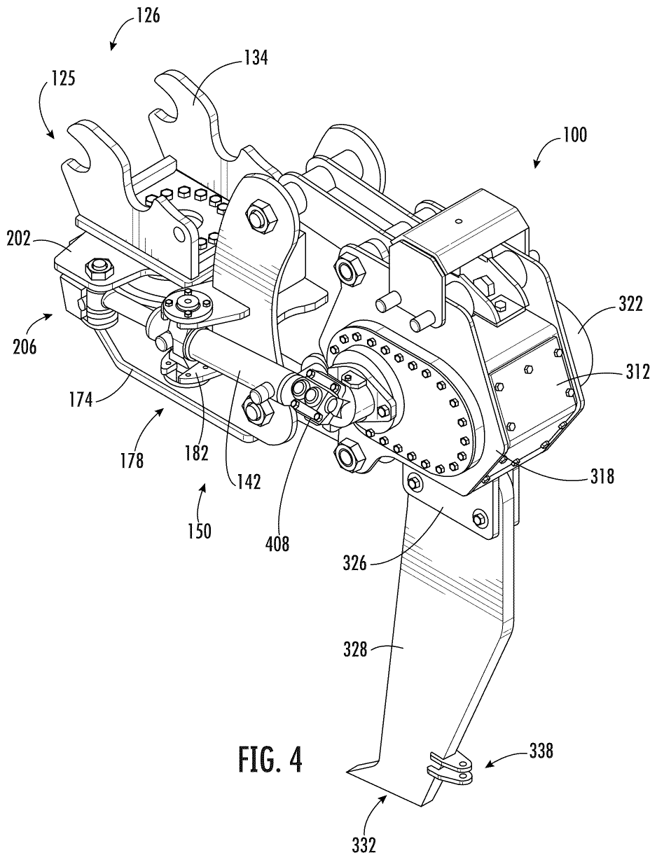

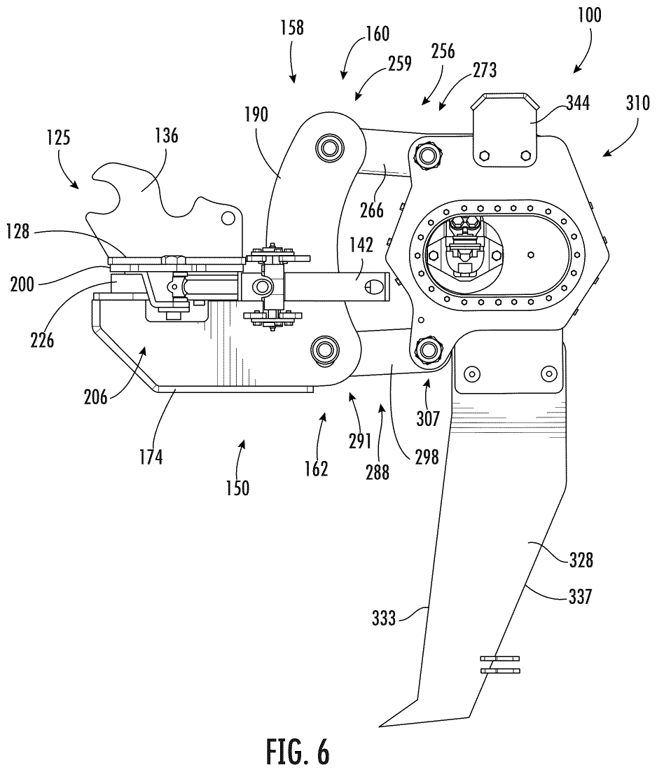

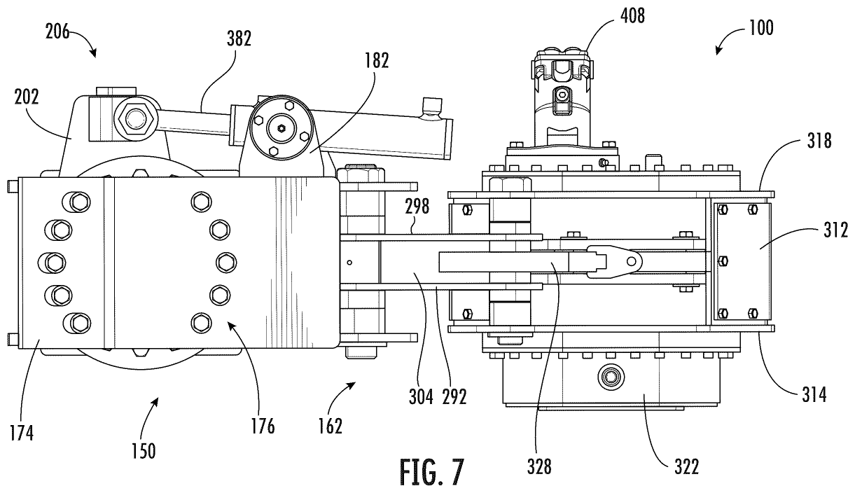

In an implementation, the mounting assembly 126 (as shown in FIGS. 2-7) has ears 132 formed by parallel adjacent first and second side plates 134, 136 and form rearward facing recesses 123, 125. A fixture at the second end 114 of the boom arm 110 is adapted to engage the recesses 123, 125 and the fixture is then further secured to the mounting assembly 126 allowing the excavator 103 to move the drop plow system 100.

In an implementation of the mounting assembly, the assembly is formed by generally parallel first and second side plates extending from the mounting plate 128. Spaced apart first and second pins extend transversely between the side plates providing an attachment point for the fixture of the boom arm 110 to form a connection between the mounting assembly and the boom arm 110.

The chassis 152 is manufactured from metal and is rotatably connected to the boom arm 110 for controlling the direction of the blade 328. In an implementation, the chassis 152 is rotatably connected to the boom arm 110 by a pivot bearing assembly 220 disposed between the boom arm 110 and chassis 152.

Referring to FIGS. 2-8, the chassis 152 is connected to the boom arm 110 with a pivot bearing assembly 220 disposed between a stage 200 and a platform 154 providing a rotation connection between the mounting assembly 126 and chassis 152. The stage 200 forms a circular pattern of holes 208. The pivot bearing assembly 220 includes an inner ring 222 and an outer ring 226 and rolling elements sealed therebetween to provide smooth rotational movement between the boom arm 110 and chassis assembly 150. The inner ring 222 forms a circular pattern of holes 224, and the outer ring 226 forms a circular pattern of holes 228. The mounting plate 128 forms a circular pattern of holes 130 that align with the stage 200 circular pattern of holes 208 and the inner ring 222 pattern of holes 224 for securing the mounting assembly 126 to the stage 200 and a pivot bearing assembly 220 of the chassis assembly 150 by fasteners 210, such as a nut and bolt combination. The platform 154 forms a circular pattern of holes 156 that align with the outer ring 226 pattern of holes 228 for securing the pivot bearing assembly 220 to the platform 154 by fasteners 210.

The platform 154 is attached to a support 158, such as by welding, forming the first connection point 160 and the second connection point 162 for the shaker assembly 310. In an implementation, the support 158 is formed by a first side plate 164 and adjacent second side plate 184 welded to the platform 154. The first side plate 164 is at the left side and forms a lower arm 166 supporting the platform 154 extending rearward from a lower aperture 168, and forms an upper arm 170 extending upward from the lower aperture 168 to an upper aperture 172. The second side plate 184 is at the right side and forms a lower arm 186 supporting the platform 154 extending rearward from a lower aperture 188, and forms an upper arm 190 extending upward from the lower aperture 188 to an upper aperture 192. The upper apertures form the first connection point 160 and the lower apertures from the second connection point 162.

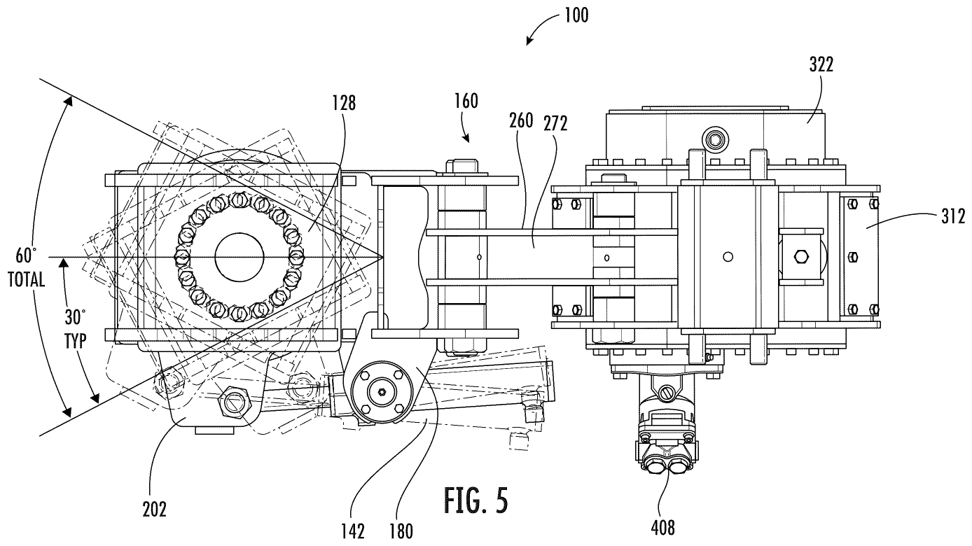

The stage 200 forms a laterally extending arm 202 adapted to pivotally receive an end of an actuator 142 for rotating the chassis 152 and shaker assembly 310 about the end of the boom arm 110. FIG. 5 illustrates pivoting of the drop plow system 100 with respect to the mounting assembly 126. In an implementation, the system 100 pivots approximately 30 degrees left and right of a normal linear alignment of the blade 328 and mounting assembly 126, for a full pivoting range of approximately 60 degrees.

In an implementation, the arm 202 forms a clevis assembly 206 for pivotally receiving the end of the actuator 142 using a pin as shown. The actuator 142 is pivotally connected to chassis 152 by an actuator mount 178 welded to the support 158, such as the second side plate 184. In an implementation, the actuator mount 178 is formed by adjacent first and second plates 180, 182 adapted to pivotally receive the actuator 142. The actuator 142 extends from a first end 144 operably connected to the arm 202 to an attachment point. In an implementation, the attachment point is a trunnion bearing 148 connected to the actuator 142, such as a hydraulic cylinder 382 between the first end 144 and a second end 146, such as the body of the hydraulic cylinder 382, allowing the second end 146 to move freely. The actuator 142 and stage 200 assembly permits the blade 328 to rotate about the second end 114 of the boom arm 110, providing flexibility for the operator in positioning the blade 328 with respect to the boom arm 110, and facilitating alignment of the blade 328 with a desired path through the ground, such as when moving around obstacles, or adjusting the direction or depth of the trench. This functionality is an improvement to vibratory drop plow systems that are limited to creating a trench only in a straight line.

A bottom plate 174 extends from the platform 154 along the bottom edge of the lower arms 166, 186 adding structural rigidity to the chassis 152. A pattern of holes 176 in the bottom plate 174 provide access to the fasteners 210 securing the pivot bearing assembly 220 to the platform 154.

The shaker assembly 310 has a metal housing 312 connected to the support 158 by upper and lower metal dampening arms 256, 288. The upper dampening arm 256 extends from a first end 258 pivotally connected to the first connection point 160 to a second end 286 pivotally disposed above the housing 312. The lower dampening arm 288 extends from a first end 290 pivotally connected to the second connection point 162 to a second end 306 pivotally connected between the side plates 314, 318 at a second pivot point 307. The pivoting connections can be made by pins or nut and bolt combinations passing through apertures in the housing 312 and arms 256, 288.

The housing 312 includes a first side plate 314 at the left side forming an upper portion with an upper aperture and a lower portion with a lower aperture, and a second side plate 318 at the right side forming an upper portion with an upper aperture and a lower portion with a lower aperture. Between the first end 258 and second end 286 is a second pivot point 273 pivotally attaching the upper dampening arm 256 to the upper apertures, between the side plates 314, 318 by a pin or nut and bolt combination. Forward of the second pivot point 273 is a vibration dampening material to absorb vibration from the shaker assembly 310 during use and minimize transfer of the vibration to the skid steer loader 102 and the support and articulation assembly. In an implementation, the dampening material is silicone or rubber and provides the connection between the second end 286 and the shaker assembly 310. A first dampening puck 274 is disposed between the first side plate 314 and the upper dampening arm 256, and a second dampening puck 276 is disposed between the second side plate 318 and the upper dampening arm 256. An additional dampening puck may be included adjacent the first and second dampening pucks 274, 276. A lower dampening puck 282 is disposed between the second end 286 and the top of the housing 312 of the shaker assembly 310. In an implementation, the shaker assembly 310 further includes a damper top plate 340 connected to the shaker assembly 310 and positioned above the upper dampening arm 256, with an upper dampening puck 278 between the upper dampening arm 256 and the damper top plate 340. The damper top plate 340 may be supported by a first damper side plate 342 at the left side connected to the damper top plate 340 and first side plate 314, and a second damper side plate 344 at the right side connected to the damper top plate 340 and second side plate 318. The dampening pucks are secured to the upper dampening arm 256 and adjacent structure such as by a bolt.

In an implementation, the upper dampening arm 256 is composed of a first side plate 260 and an adjacent second side plate 266, with a gusset 272 extending between the side plates adding rigidity to the arm, an upper plate connecting the side plates to the upper dampening puck 278, and a lower plate connecting the side plates to the lower dampening puck 282. Further, the lower dampening arm 288 may be composed of a first side plate 292 and an adjacent second side plate 298, with a gusset 304 extending between the side plates adding rigidity to the arm. The above components of the dampening arms are manufactured from metal and may be welded to each other.

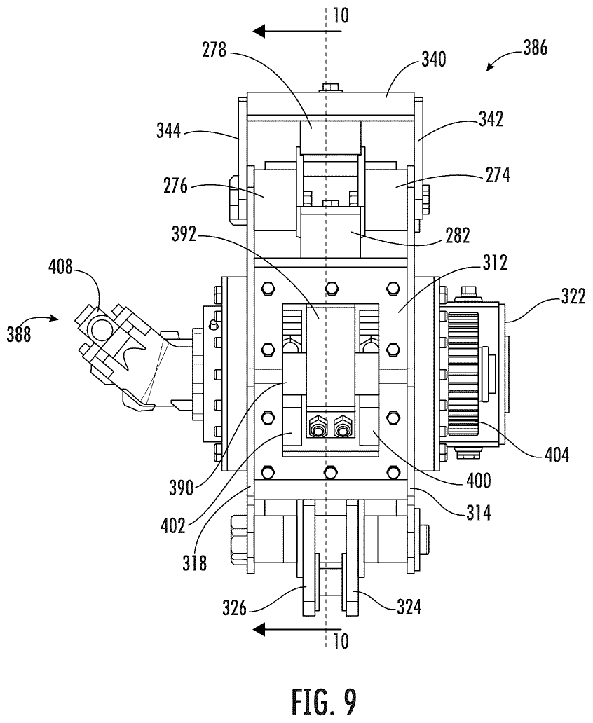

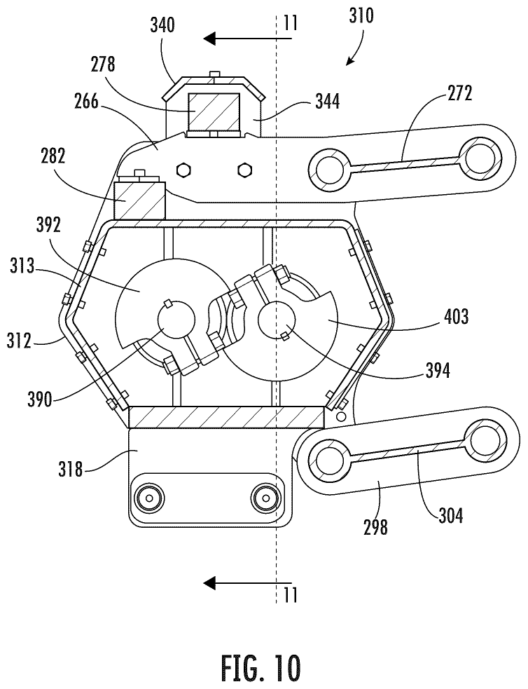

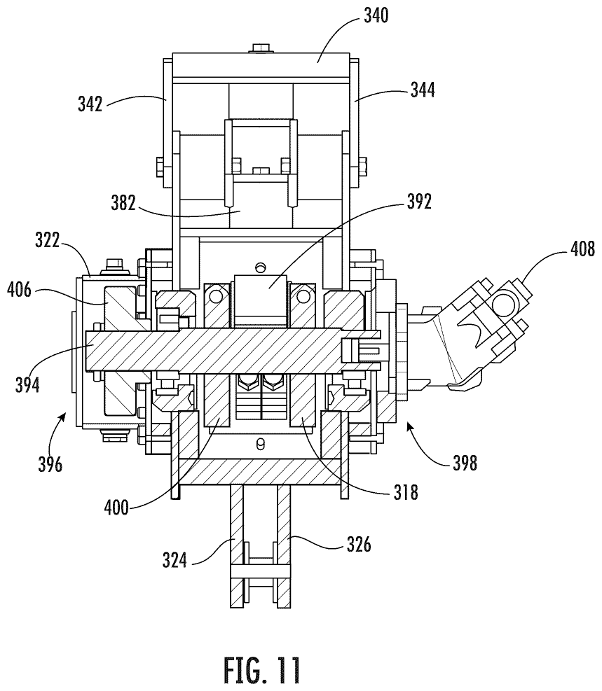

Referring to FIGS. 9-11, the shaker assembly 310 is formed from metal includes a shaker weight assembly 386 with at least one weight attached to a rotatable shaft within the housing 312 driven by a power source, with the blade 328 being operably attached to the housing 312. The housing 312 may include a front cover 313. In an implementation, the shaker weight assembly 386 includes adjacent first and second shafts 390, 394, mounted on bearings on each end, with the second shaft 394 having a centrally located first weight 392 with a mass adjacent the first shaft 390, and with the second shaft 394 extending from a first end 396 to a second end 398 with a second weight 400 adjacent the first end 396 with a mass adjacent the second shaft 394 and a third weight 402 adjacent the second end 398 with a mass adjacent the second shaft 394. Adjacent ends of the shafts 390, 394 include cooperating gears 404, 406 within a gear housing 322 permitting the power source operably connected to one of the shafts to rotate both of the shafts. In an implementation, the power source is connected to the second shaft 394. The power source can assume a variety of configurations, and can be powered in a variety of ways, such as electrically and hydraulically. In an implementation, the power source is a hydraulic motor 408 driven by the hydraulic system 372. The shafts 390, 394 are spaced apart permitting the weight masses to move within the housing 312 in a manner whereby the weights do not hit each other, or the adjacent shafts. In an embodiment, the rotational path of the first weight 392 is between the rotational path of the second and third weights 400, 402. The weights are positioned on each shaft to result in an imbalance during rotation that results in forces that move the shaker assembly forward and rearward, and upward and downward, inducing movement analogous to a shaking motion or a vibration. This movement is transmitted to the blade 328.

In an implementation, the blade 328 is detachable from the base housing 312. The base may include adjacent first and second blade mounting plates 324, 326 for attaching a proximal end 330 of the blade 328 with fasteners 331, such as a nut and bolt combination, by passing the fasteners 331 through apertures in the plates 324, 326 and blade 328. The detachability facilitates replacement of a worn or damaged blade 328, or if there is a desire to use a blade 328 with different structural characteristics.

The blade 328 is formed from metal and extends from the proximal end 330 to a distal end 332 forming a rearward-facing tip 334. A person of skill in the art will appreciate the selection of the material (hardened steel, etc.) of the blade 328 and tip 334, and shape of the tip 334, is influenced by the condition of the soil the blade 328 is used with. The leading edge 333 of the blade 328 may be flat, angular, or convex depending on the condition of the soil, allowing the blade 328 to cleave and plow through the ground and subsoil. The trailing edge 337 of the blade 328 may include an extension 338 for attachment of an object, such as a chain or cable, for attachment to material, such as conduit or cabling, to pull such material through the trench created by the blade 328. In an implementation, the extension 338 is one plate or two plates welded to the blade 328 with an aperture for attaching a chain or cable. A wedge 336 structure located rearward of the extension 338 aids in creating an opening in the ground wider than the width of the blade 328 to facilitate placing material in the ground. In an implementation, the wedge 336 structure is formed by a triangular-shaped wedge structure extending from a narrow tip rearward toward the trialing edge 337 forming a wide base. In an implementation, the wedge 336 is formed by upper and lower triangular shaped surfaces. The upper triangular shaped surface extends from a narrow tip at the rear forward to a wide base portion, with an upper edge extending upward and forward along the body of the blade 328, and a lower edge extending outward from the body of the blade 328. The lower triangular shaped surface extends from a narrow tip at the rear forward to a wide base portion, with an upper edge extending outward from the body of the blade 328 in conjunction with the upper triangular shaped surface lower edge, and a lower edge extending downward and forward along the body of the blade 328.

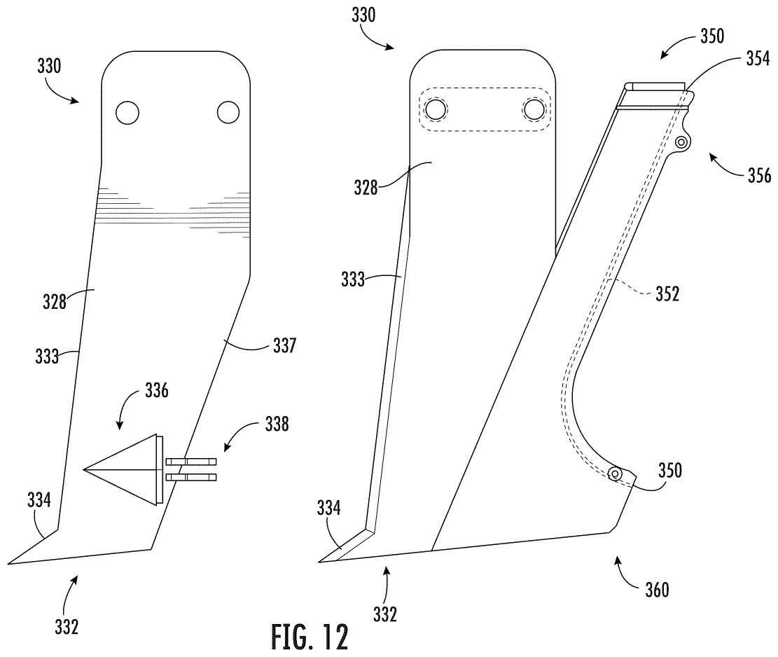

Referring to FIG. 12, in an implementation, the blade 328 may include a passage permitting the laying or burying of material within the trench when plowing. In an implementation, a chute blade 350 manufactured from metal attachable to the blade 328 by welding or by fasteners, incudes a passage 352 extending from an opening 354 at a first end 356 to a trailing edge opening 358 at a second end 360. The passage 352 may transition from a generally straight orientation at the first end 356 to a generally horizontal orientation at the second end 360 at the trailing edge opening 358. As the blade 328 moves in a rearward direction the material, such as conduit or cabling, enters the opening 354 generally above the ground in a generally vertical orientation, and exits the passage 352 at the trailing edge opening 358 at a generally horizontal orientation below the surface, burying the material within the trench.

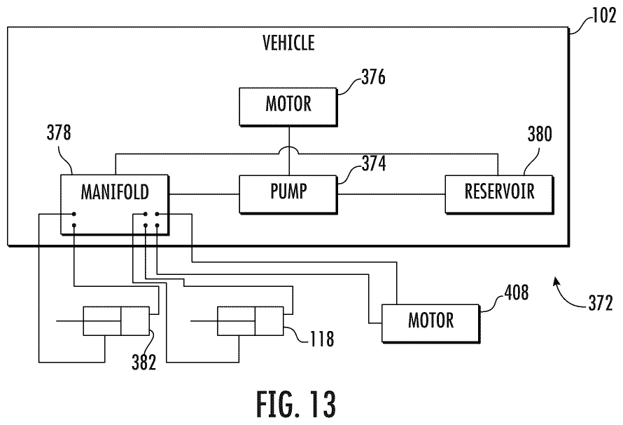

In an implementation the actuator 142 is a hydraulic cylinder 382 connected to a hydraulic system 372. The hydraulic system 372 can be independent of the vehicle 102, or it can be part of the vehicle 102. Referring to FIG. 13, an exemplary hydraulic system 372 with a hydraulic pump 374 is powered by the vehicle 102 motor 376 for use with the drop plow system 100. In an implementation, the hydraulic cylinder 382 is fluidly connected to the hydraulic system of the vehicle 102. The hydraulic cylinder 382 is connected by hydraulic hoses to a hydraulic valve assembly of a manifold 378 and a hydraulic reservoir 380. The power source is operably connected to the manifold 378 and reservoir 380 by hoses. The pump 374 is connected to a manifold 378 for providing hydraulic fluid to the hydraulic cylinder 382 and power source. The hydraulic system 372 is operated in a conventional manner.

In use, an operator of the vehicle 102 connects the boom arm 110 to the mounting assembly 126, and makes the necessary electrical and hydraulic power connections to the actuator 142 and power source. The operator moves the excavator 103 and drop plow system 100 to a location to start insertion of the desired material or the desired trench begin position into the ground. An operator lowers the blade 328 by lowering the boom arm 110 to engage the blade 328 with the ground, and engages the power source causing the shafts 390, 394 of the shaker weight assembly 386 to rotate, inducing vibration into the blade 328 reducing resistance to the blade 328 moving through the ground. The operator moves the excavator 103 or boom arm 110 in the rearward direction causing the blade 328 to move in a rearward direction causing the leading edge 333 to separate the soil creating a trench within the ground. The operator can adjust the depth of the blade 328 within the ground by actuating the boom arm 110 actuators 118 to form the base of the trench at the desired depth, and place any material exiting the trailing edge opening 358 at the desired depth. The operator can actuate the actuator 382 rotating the shaker assembly 310 and blade 328 about the end of the boom arm 110 as the arm moves rearward, such as by movement of the boom arm 110 or by rotation of the excavator cab 104 about the tracks 108, allowing the blade 328 to form a curved portion of the trench 112. When the operator reaches the location to cease creating the trench, the boom actuators 118 are actuated to disengage the blade 328 from the ground, and the power source 288 is disengaged, ceasing vibration of the shaker assembly 310 and blade 328. Material, such as cabling or conduit may be fed into the opening 354 of the passage 352 formed by either the blade 328 or a chute blade 350 attached to the blade 328 at the beginning of the trenching process, with the material exiting the passage 352 at the end of the trenching process.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Having described the disclosed subject matter, what is claimed as new and desired to be secured by Letters Patent is:

1. A soil-shifting device for attachment to a vehicle, the device comprising:
a mounting assembly for connecting the device to a vehicle;
a chassis, comprising:
a platform;
a support connected to the platform, wherein the support forms a first connection point and a second connection point;
wherein the mounting assembly is rotatably connected to the platform;
a plow blade for forming a trench in soil, wherein the plow blade is operably connected to first connection point and the second connection point.

2. The device of claim 1, comprising:
wherein the mounting assembly further comprises a plate; and
wherein the chassis further comprises a stage disposed between the mounting assembly and platform, wherein the stage is operably connected to the plate.

3. The device of claim 2, comprising:
a pivot bearing assembly disposed between the platform and the stage providing a rotation connection between the mounting assembly and chassis.

4. The device of claim 1, comprising:
a shaker assembly connected to the first connection point and the second connection point; and
wherein the plow blade is attached to the shaker assembly.

5. The device of claim 4, comprising:
wherein the shaker assembly comprises:
a housing with an upper pivot point and a lower pivot point;
an upper dampening arm extending from a first end to a second end, wherein the first end is pivotally connected to the support first connection point, and wherein the upper dampening arm is pivotally connected to the upper pivot point between the first end and second end; and
a lower dampening arm extending from a first end to a second end, wherein the first end is pivotally connected to the support second connection point, and wherein the second end is pivotally connected to the lower pivot point.

6. The device of claim 5, comprising:
wherein the shaker assembly further comprises:
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.

7. The device of claim 1, comprising:
wherein the chassis further comprises:
a stage;
a first side plate connected to the stage, wherein the first side plate forms an upper aperture and a lower aperture;
a second side plate connected to the stage, wherein the second side plate forms an upper aperture and a lower aperture; and
wherein the upper apertures form the first connection point, and the lower apertures from the second connection point;
wherein the mounting assembly is operably connected to the stage; and
a pivot bearing assembly disposed between the platform and the stage; and
wherein the mounting assembly is rotatably connected to the platform by the pivot assembly.

8. The device of claim 7, comprising:
an actuator operably connected at a first connection point to the stage and operably connected at a second connection point to the support; and
wherein the actuator rotates the stage about the support.

9. The device of claim 1, comprising:
wherein the plow blade extends from a first end to a second end;
wherein the plow blade forms a passage extending from the first end to the second end, the passage transitioning from a generally straight orientation to a generally horizontal orientation at the second end.

10. A soil-shifting device for attachment to a vehicle, the device comprising:
a mounting assembly, comprising;
a mounting plate;
a first ear extending from the mounting plate;
a second ear extending from the mounting plate; and
wherein the ears are adapted to engage a vehicle;
a chassis, comprising:
a support forming a first connection point and a second connection point;
a stage rotatably connected to the support;
an actuator operably connected to the stage and the support for rotating the stage about the support;
a plow blade for forming a trench in soil; and
wherein the plow blade is operably connected to first connection point and the second connection point.

11. The device of claim 10, comprising:
wherein the actuator extends from a first end to a second end;
an attachment point disposed between the first end and second end;
wherein the first end is pivotally connected to the stage; and
wherein the attachment point is pivotally connected to the support.

12. The device of claim 10, comprising:
wherein the stage forms a laterally extending arm adapted to pivotally receive an end of the actuator.

13. The device of claim 12, comprising:
wherein the arm forms a clevis assembly for pivotally receiving the first end of the actuator.

14. The device of claim 10, comprising:
a shaker assembly connected to the first connection point and second connection point; and
wherein the plow blade is attached to the shaker assembly for forming a trench in the soil.

15. The device of claim 14, comprising:
wherein the shaker assembly includes a housing;
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.

16. The device of claim 10, comprising:
wherein the plow blade extends from a first end to a second end;
wherein the plow blade forms a passage extending from the first end to the second end, the passage transitioning from a generally straight orientation to a generally horizontal orientation at the second end.

17. A soil-shifting device for attachment to a vehicle, the device comprising:
a mounting assembly, comprising;
a mounting plate;
a first ear extending from the mounting plate; and
a second ear extending from the mounting plate; and
wherein the ears are adapted to engage a vehicle;
a chassis, comprising:
a support, comprising:
a stage;
a first side plate connected to the stage, wherein the first side plate forms an upper aperture and a lower aperture;
a second side plate connected to the stage, wherein the second side plate forms an upper aperture and a lower aperture;
wherein the upper apertures form a first pivot connection, and wherein the lower apertures form a second pivot connection;
a shaker assembly operably connected to the first pivot connection and second pivot connection for inducing a shaking movement; and
an elongated plow blade depending from the shaker assembly for forming a trench in soil.

18. The device of claim 17, comprising:
an actuator extending from a first end to a second end;
an attachment point disposed between the first end and second end;
wherein the first end is pivotally connected to the stage; and
wherein the attachment point is pivotally connected to the support.

19. The device of claim 18, comprising:
wherein the stage forms a clevis assembly for pivotally receiving the first end of the actuator; and
wherein the support forms adjacent first and second plates adapted to pivotally receive the attachment point.

20. The device of claim 17, comprising:
wherein the shaker assembly includes a housing;
a first rotatable shaft within the housing;
a second rotatable shaft within the housing adjacent the first rotatable shaft;
a first weight attached to the first rotatable shaft;
a second and third weight attached to the second rotatable shaft; and
wherein rotation of the shafts generates a shaking motion.

21. The device of claim 17, comprising:
wherein the plow blade extends from a first end to a second end;
wherein the plow blade forms a passage extending from the first end to the second end, the passage transitioning from a generally straight orientation to a generally horizontal orientation at the second end.
